(19) United States
(12) Patent Application Publication
(10) Pub. No.: US 2002/0171743 A1
(43) Pub. Date: Nov. 21, 2002

(54) Electronic device and digital still camera

(75) Inventors: Keita Kimizuka, Tokyo (JP); Shuji Hayashi, Tokyo (JP); Chie Nemoto, Tokyo (JP); Etsuko Rokutanda, Tokyo (JP)

Correspondence Address: Finnegan, Henderson, Farabow, Garrett & Dunner, L.L.P., 1300 I Street, N.W., Washington, DC, 20005-3315, US

(73) Assignee: KONICA CORPORATION

(21) Appl. No.: 10/140,299

(22) Filed: May 8, 2002

(30) Foreign Application Priority Data
May 16, 2001 (JP) 146001/2001

(51) Int. Cl. H04N 7/12

(52) U.S. Cl. 348/222.1; 375/240.01

(57) ABSTRACT

There are described an electronic device and a digital still camera, which make it possible to generate or transmit coded data in a format convenient for each of peripheral devices to which the coded data are transmitted. The electronic device or the digital still camera includes a processor to compress image data by coding the image data, so as to generate coded data; a data communicating section to perform a bilateral data-communication with a peripheral device; and a determining section to determine a coding method for coding the image data, based on information pertaining to the peripheral device, which are acquired by the data communicating section. The processor codes the image data on the basis of the coding method determined by the determining section to generate the coded data. The determining section determines an arrangement order of the coded data based on the information pertaining to the peripheral device.

### BACKGROUND OF THE INVENTION

The present invention relates to an electronic device and a digital still camera, specifically relates to peripheral devices that process data generated by an electronic device or a digital still camera, and further, desirably relates to an electronic device and a digital still camera, which make it possible to generate or transmit coded data in a format convenient for each of the peripheral devices to which the coded data are transmitted.

In the electronic device, such as a digital still camera, etc., a subject image projected onto an imager, such as a CCD, etc., is converted into multi-valued image data. Since the multi-valued image data include a considerably large amount of information, when storing them into an external memory device, such as a memory card, etc., or transmitting them to a peripheral device, such as a computer terminal, a printer, a portable remote terminal, etc., it has been a problem that a large amount of workload makes the processing time considerably long.

Accordingly, to reduce the amount of data to be stored in the memory and to accelerate a transmitting-speed of the data, the data-compression processing for drastically reducing an amount of data has been generally conducted by coding the multi-valued image data into a compressed form.

JPEG, which is the international standardized method for coding a still image, has been well known as one of conventional coding-compression technologies, in which image data of the original image is divided into a plurality of blocks, and a DCT coefficient is derived from a pixel value in each of the blocks by employing the Discrete Cosine Transformation (DCT), and then, the coding is conducted after the DCT coefficient is quantized in the predetermined quantize steps.

It has been a problem, however, that, when the coded data are transmitted to a printer, serving as one of the peripheral devices, since it is desired that the printing operation is commenced at an early stage of the data-transmitting operation, sequential data-transmitting method should be employed for transmitting the whole coded data of an image, and in this case, the whole contents of the image cannot be recognized until the transmission of the whole coded data is completed.

On the other hand, the progressive-coding method, which makes it possible to grasp the rough contents of the image at the early stage of the data-transmitting operation by gradually fining the image pixels, is specified one of the expanded methods of JPEG. In this method, however, it has been a problem that, when the coded data are transmitted to a printer, serving as one of the peripheral devices, the printing operation cannot be commenced until the transmission of the whole coded data is completed.

Further, there has been another problem that, sometimes, depending on a capacity of the receiving peripheral device to which the coded data are transmitted, the size of the whole data is too large to transmit, resulting in not only waist of time for transmitting the data, but also loss of the coded image data itself.

### SUMMARY OF THE INVENTION

To overcome the abovementioned drawbacks in conventional electronic devices and digital still cameras, it is an object of the present invention to provide an electronic device or a digital still camera, which makes it possible to generate or transmit the coded data in a format convenient for each of the peripheral devices to which the coded data are transmitted, and which is good in maneuverability.

Accordingly, to overcome the cited shortcomings, the abovementioned object of the present invention can be attained by electronic devices and digital still cameras described as follow.

(1) An electronic device, comprising: a processor to compress image data by coding the image data, so as to generate coded data; a data communicating section to perform a bilateral data-communication with a peripheral device; and a determining section to determine a coding method for coding the image data, based on information pertaining to the peripheral device, which are acquired by the data communicating section; wherein the processor codes the image data on the basis of the coding method determined by the determining section to generate the coded data.

(2) The electronic device of item 1, wherein the determining section determines an arrangement order of the coded data based on the information pertaining to the peripheral device, and the processor codes the image data based on the arrangement order of the coded data.

(3) The electronic device of item 2, wherein the processor applies a Wavelet transform to the image data to generate hierarchical structured data for each of different frequency-bands, and divides the hierarchical structured data into a plurality of block areas, so that the image data are compressed by coding them in each of the plurality of block areas.

(4) The electronic device of item 2, wherein the determining section determines either a hierarchical coding method or a sequential coding method as the coding method to be employed.

(5) The electronic device of item 4, wherein, when the determining section determines the hierarchical coding method as the coding method to be employed, the processor generates the coded data based on the information pertaining to the peripheral device.

(6) The electronic device of item 1, further comprising: a photographing optical system; and an imager to opt-electronically convert an optical image, projected onto the imager by the photographing optical system, to the image data; wherein the processor applies a Wavelet transform to the image data generated by the imager.

(7) A digital still camera, comprising: a photographing optical system; an imager to opt-electronically convert an optical image, projected onto the imager by the photographing optical system, to image data; a processor to compress the image data by coding the image data, so as to generate coded data; a data communicating section to perform a bilateral data-communication with a peripheral device; and a determining section to determine a coding method for coding the image data, based on information pertaining to the peripheral device, which are acquired by the data communicating section; wherein the processor codes the image data on the basis of the coding method determined by the determining section to generate the coded data.

(8) The digital still camera of item 7, wherein the determining section determines an arrangement order of the coded data based on the information pertaining to the peripheral device, and the processor codes the image data based on the arrangement order of the coded data.

(9) The digital still camera of item 8, wherein the processor applies a Wavelet transform to the image data to generate hierarchical structured data for each of different frequency-bands, and divides the hierarchical structured data into a plurality of block areas, so that the image data are compressed by coding them in each of the plurality of block areas.

(10) The digital still camera of item 8, wherein the determining section determines either a hierarchical coding method or a sequential coding method as the coding method to be employed.

(11) The digital still camera of item 10, wherein, when the determining section determines the hierarchical coding method as the coding method to be employed, the processor generates the coded data based on the information pertaining to the peripheral device.

(12) A digital still camera, comprising: a photographing optical system; an imager to opt-electronically convert an optical image, projected onto the imager by the photographing optical system, to image data; an image-processing section to apply a Wavelet transform to the image data acquired by the imager to generate hierarchical structured data for each of different frequency-bands, and divides the hierarchical structured data into a plurality of block areas, so that the image data are compressed by coding them in each of the plurality of block areas; a data communicating section to perform a bilateral data-communication with a peripheral device; and a data conversing section to rearrange a transmitting order of coded data in each of the plurality of block areas in respect to the peripheral device, based on information pertaining to the peripheral device, which are acquired by the data communicating section.

(13) The digital still camera of item 12, wherein the data conversing section rearranges the transmitting order of the coded data in either a first format in which the coded data are transmitted step by step from low-resolution to high-resolution, or a second format in which the coded data are sequentially transmitted.

(14) The digital still camera of item 13, wherein, in case of employing the first format, the data conversing section deletes unnecessary high-resolution data from the coded data, based on the information pertaining to the peripheral device, which are acquired by the data communicating section.

(15) The digital still camera of item 14, further comprising: a warning section to warn that a part of the coded data is deleted by the data conversing section.

(16) An electronic device, comprising: an image-processing section to apply a Wavelet transform to image data to generate hierarchical structured data for each of different frequency-bands, and divides the hierarchical structured data into a plurality of block areas, so that the image data are compressed by coding them in each of the plurality of block areas; a data communicating section to perform a bilateral data-communication with a peripheral device; and a data conversing section to rearrange a transmitting order of coded data in each of the plurality of block areas in respect to the peripheral device, based on information pertaining to the peripheral device, which are acquired by the data communicating section.

(17) A digital still camera, comprising: a photographing optical system; an imager to opt-electronically convert an optical image, projected onto the imager by the photographing optical system, to image data; an image-processing section to apply a Wavelet transform to the image data acquired by the imager to generate hierarchical structured data for each of different frequency-bands, and divides the hierarchical structured data into a plurality of block areas, so that the image data are compressed by coding them in each of the plurality of block areas; a data communicating section to perform a bilateral data-communication with a peripheral device; and a recompressing section to recompress image data compressed by the image-processing section, based on information pertaining to the peripheral device, which are acquired by the data communicating section.

(18) An electronic device, comprising: an image-processing section to apply a Wavelet transform to image data to generate hierarchical structured data for each of different frequency-bands, and divides the hierarchical structured data into a plurality of block areas, so that the image data are compressed by coding them in each of the plurality of block areas; a data communicating section to perform a bilateral data-communication with a peripheral device; and a recompressing section to recompress image data compressed by the image-processing section, based on information pertaining to the peripheral device, which are acquired by the data communicating section.

### BRIEF DESCRIPTION OF THE DRAWINGS

Other objects and advantages of the present invention will become apparent upon reading the following detailed description and upon reference to the drawings in which:

FIG. 1 shows a rough block diagram of a whole configuration of a digital still camera embodied in the present invention;

FIG. 2 shows a configuration of an arithmetic processing section embodied in the present invention;

FIG. 3(a), FIG. 3(b), FIG. 3(c) and FIG. 3(d) show explanatory illustrations of states in which image data are divided into a plurality of sub-bands;

FIG. 4 shows a configuration of filters in the Wavelet transform;

FIG. 5 shows an explanatory illustration of a state of converting image data into bit-planes;

FIG. 6 shows an explanatory illustration of an example of dividing one of the sub-blocks into coded blocks;

FIG. 7 shows an example of a configuration of an image file when expanding it step-by-step form low-resolution data;

FIG. 8(a) and FIG. 8(b) show examples of a hierarchical expression of compressed image data, specifically, FIG. 8(a) shows an example, in which the resolution increases step by step from image A of low resolution and FIG. 8(a) shows each of compressed image data for each block;

FIG. 9 shows an example of a configuration of an image file when expanding it from an upper portion of an image;

FIG. 10 shows an example of a configuration of an image file when expanding it step-by-step form low-resolution data after deleting high-resolution image data;

FIG. 11 shows an example of a configuration of an image file when expanding it from an upper portion of an image after deleting high-resolution image data;

FIG. 12 shows another configuration of an arithmetic processing section embodied in the present invention; and

FIG. 13 shows an example of coded image data compressed by employing the sequential coding method.

### DETAILED DESCRIPTION OF THE PREFERRED EMBODIMENT

The embodiment of the present invention will be detailed in the following.

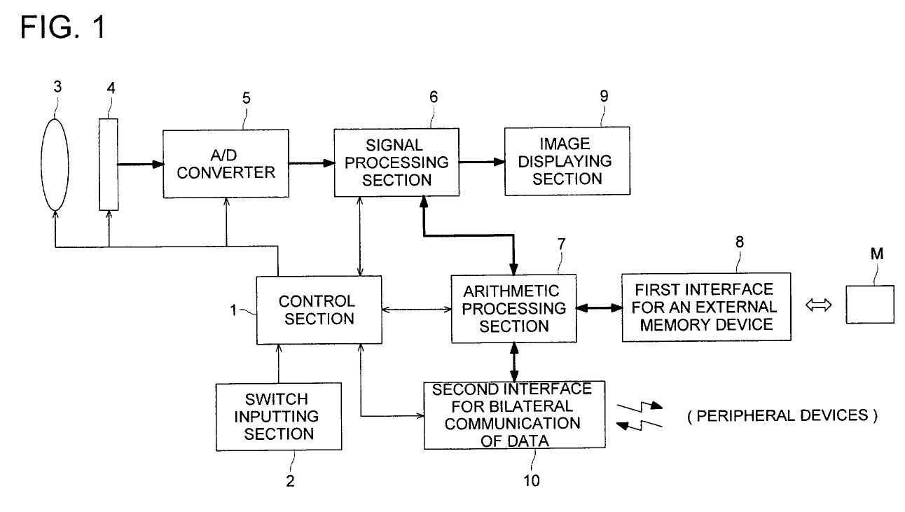

FIG. 1 shows a rough block diagram of a whole configuration of a digital still camera, serving as an electronic device embodied in the present invention. In FIG. 1, numeral 1 indicates a control section, numeral 2 indicates a switch inputting section, numeral 3 indicates a photographing optical system, numeral 4 indicates an imager serving as a photographing element, numeral 5 indicates a A/D (Analogue to Digital) converter, numeral 6 indicates a signal processing section, numeral 7 indicates an arithmetic processing section, numeral 8 indicates a first interface for an external memory device, numeral 9 indicates a image displaying section and numeral 10 indicates a second interface for bilateral communication of data.

Control section 1 activates and controls sequential operations including photographing, recording, playback and data transmitting/receiving operations, based on the signals inputted from switch inputting section 2, in which a power switch, various kinds of operational switches, etc., are mounted.

In the photographing/recording operation, an optical image, formed by photographing optical system 3 including a lens, etc., is projected onto the photo-receiving surface of imager 4, such as a CCD (Charge Coupled device), etc. Then, imager 4 converts the projected optical image to analogue image signals in its opto-electronic converting process, and the analogue image signals are inputted into A/D converter 5.

A/D converter 5 converts the analogue image signals inputted from imager 4 to digital image signals for every pixel, and sends them to signal processing section 6. Signal processing section 6 further converts chrominance components (R, G, B) of the digital image signals for every pixel to luminance color-difference signals, and sends them to arithmetic processing section 7, serving as an image processing means. In arithmetic processing section 7, the image-compression processing is applied to the luminance color-difference signals converted from the digital image signals.

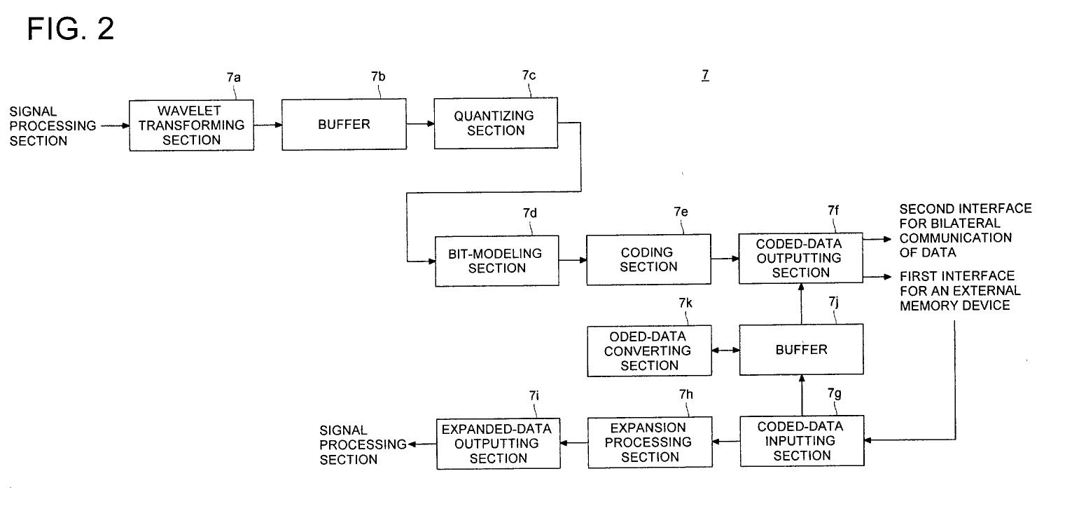

FIG. 2 shows a configuration of arithmetic processing section 7, which will be detailed in the following. In the embodiment of the present invention, a method for coding the digital image signals by using the discrete Wavelet transform is employed.

At first, in Wavelet transforming section 7a of arithmetic processing section 7, the discrete Wavelet transforming operation is applied to the luminance color-difference signals for every pixel, converted from the digital image signals by signal processing section 6. Concretely speaking, in Wavelet transforming section 7a, the conventional discrete Wavelet transforming operation is applied to every pixel data included in one image plane inputted from signal processing section 6 so as to divide them into a plurality of frequency bands called as sub-bands.

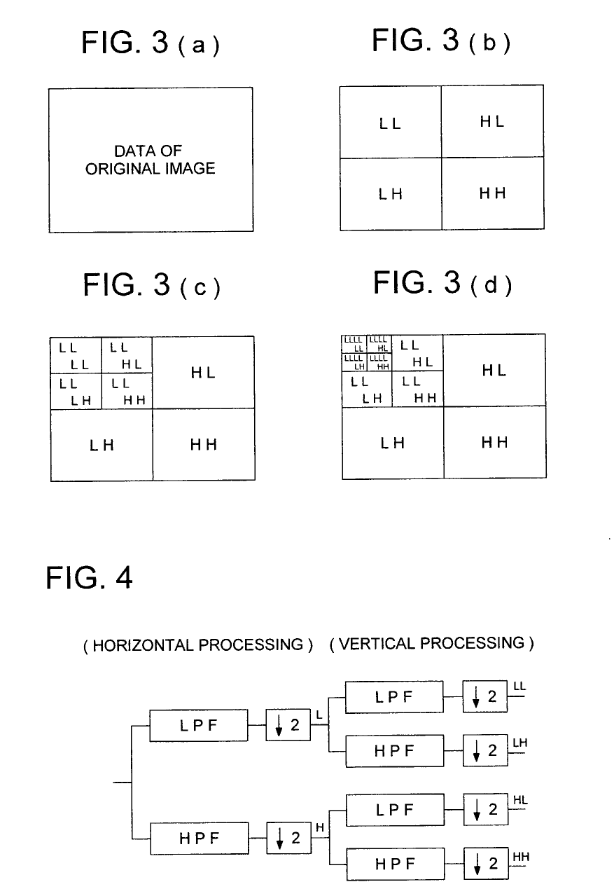

In the discrete Wavelet transform mentioned above, the original image data shown in FIG. 3(a) are filtered in an order of horizontal and vertical directions by low-pass filters (LPF) and high-pass filters (HPF) as shown in FIG. 4 to divide them into a high frequency component (H) and a low frequency component (L), and are coded to the sub-bands, by down-sampling them to ½ and dividing them into sub-blocks comprising four components of LL, HL, LH, HH, as shown in FIG. 3(b).

Next, by applying the same processing as mentioned above to component LL among the generated four sub-blocks, component LL is further divided into new four sub-blocks, so that hierarchical structured data (or multi-level structured data) are created by coding them to sub-bands and dividing them into sub-blocks comprising seven components of LLLL, LLHL, LLLH, LLHH, HL, LH, HH, as shown in FIG. 3(c).

The Wavelet conversion-coefficients (the hierarchical structured data), created by the sub-band coding operation mentioned above, are temporarily stored in buffer 7b, and then, transmitted to quantizing section 7c in the order of LLLL, LLHL, LLLH, LLHH, HL, LH, HH.

With respect to the image data having a large number of pixels, it is also possible to have larger amount of the hierarchical structured data by further dividing component LLLL into new four sub-blocks in the same process as mentioned above, as shown in FIG. 3(d).

In quantizing section 7c, the Wavelet conversion coefficients for each of the sub-bands, outputted by buffer 7b, are quantized in a quantizing step predetermined for each of the sub-bands. It is applicable, however, that the quantizing operation can be actually omitted in quantizing section 7c by setting the quantizing step at 1.

After all of the Wavelet conversion coefficients for one of the sub-bands are quantized in quantizing section 7c, the quantized values (the quantized Wavelet conversion coefficients) are outputted to coefficient bit-modeling section 7d.

In coefficient bit-modeling section 7d, the quantized values of the Wavelet conversion coefficients, quantized by quantizing section 7c, are further converted to a plurality of bit-planes BP1, BP2 - - - , BPn in the order from MSB (Most Significant Bit), having a high energy, to LSB (Least Significant Bit), having a low energy.

Next, the quantized values of the Wavelet conversion coefficients converted to the bit-planes are outputted to coding section 7e for a coding operation. In the embodiment of the present invention, coding section 7e performs the conventionally well-known arithmetic coding operation.

In coding section 7e, the quantized values of the Wavelet conversion coefficients are divided into a plurality of coded blocks (block areas, or called as code blocks) for every sub-block. FIG. 6 shows an example in which one of the sub-blocks is divided into coded blocks of 16×16. Each of the bit-planes is further divided into stripes, and the arithmetic coding operation is performed in each of the coded blocks by vertically scanning each of the stripes from the upper-right position.

Necessary header data, etc., are added to the image data coded by coding section 7e to create a compressed image data file.

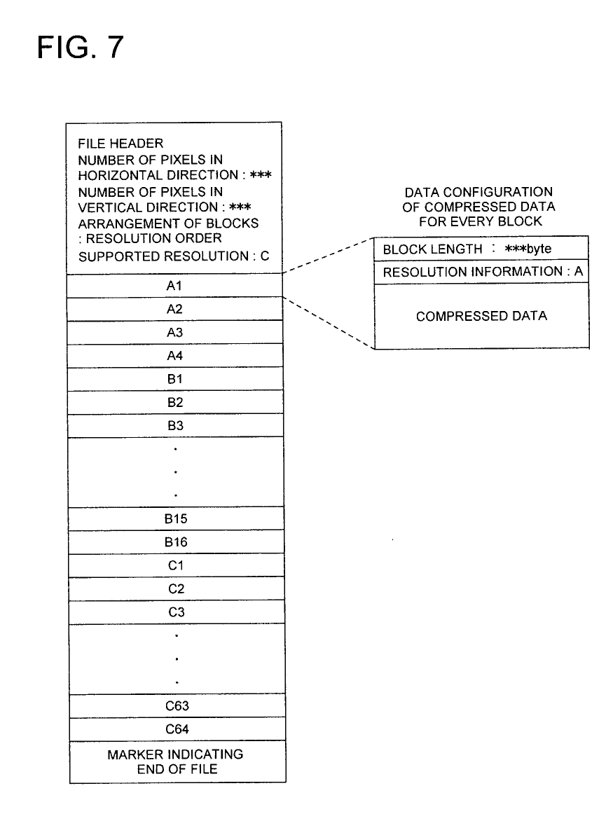

When creating, for instance, an image data file of a resolution progressive method serving as one of hierarchical coding methods, at first, header data, including numbers of pixels in both horizontal and vertical directions, arrangement of blocks, information of supported resolution, etc., are written in the header of the compressed image data file, as shown in FIG. 7, and then, the coded data of the code block of the sub-band having the lowest frequency component of the MSB bit-plane (for instance, component LLLLLL shown in FIG. 3(d)) are written in the same manner as aforementioned.

Incidentally, the hierarchical coding method is defined as such a coding method that a plurality of image planes, whose resolutions are different each other in stepwise, are generated from a single image at first, and then, a coding operation is applied to each of the generated image planes. Further, it is more desirably defined as such a coding method that a plurality of image planes, whose resolutions are different each other in stepwise, are recursively generated from a single still image at first, and then, image data of the generated image planes are shaped into a pyramid formation, in which an image plane having the lowest resolution is located at the apex of the pyramid while an image plane having the highest resolution is located at the bottom surface of the pyramid.

Next, the coded data of the code block equivalent to the position of the above code block of the image plane just under the MSB are written. The same processing as mentioned above is repeatedly performed for each of the image plane up to the LSB image plane. Further, after shifting the position of the code block, the coded data from MSB to LSB are written in the same manner as abovementioned. After the coding operation of the sub-band in respect to one of frequency components is totally completed through the abovementioned process, the coded data of the code block of the sub-band having higher frequency components are sequentially written.

Further, the length of the code block is written in the tip portion of the coded data for every code block, and, based on the above information, the image data can be rearranged in a unit of the block.

The compressed image data file, created in the abovementioned process, are outputted from coded-data outputting section 7f, and stored in external memory device M, such as a memory card, etc., through first interface 8 shown in FIG. 1.

Although the case of creating an image data file of the resolution progressive method, serving as one of hierarchical coding methods, is exemplified for explaining the method of coding in the above, the applicable method of coding is not limited to the above. A sequential coding method, in which a single image is coded step by step in order of rows of the image data, would be also applicable.

On the other hand, when reconstructing the image, the compressed image data file, read from external memory device M through first interface 8, are outputted from coded-data inputting section 7g to expansion processing section 7h, in which the expansion processing is applied to the compressed image data file. The luminance color-difference signals generated by the expansion processing are outputted from expanded-data outputting section 7i to signal processing section 6 to further convert them to the image data appropriate for displaying its image. Then, the converted image data are outputted to image displaying section 9, including a displaying device, such as a LCD (Liquid-Crystal Display), etc., to display the image.

Further, the bilateral data transmission with the external peripheral devices, such as a printer, a portable remote terminal, etc., is performed through second interface 10, serving as a data communication means. In the embodiment of the present invention, control section 1 acquires the information pertaining to a kind of peripheral device currently coupled to second interface 10, for instance, either a printer or a portable remote terminal, and the information pertaining to the outputting capacity of horizontal pixel number, vertical pixel number, etc.

Next, control section 1 reads the compressed image data file from external memory device M through first interface 8, and inputs them to coded-data inputting section 7g of arithmetic processing section 7.

The coded data, inputted to coded-data inputting section 7g, temporarily stored in buffer 7j, and then, in coded-data converting section 7k, the rows of the coded data are rearranged on the basis of the information, pertaining to the kind of peripheral device, acquired by control section 1, so that the data format becomes convenient for the peripheral device concerned.

In other words, coded-data converting section 7k serves as a data converting means, which rearranges the transmitting order of the coded data of every coded block for the peripheral device concerned on the basis of the information, pertaining to the kind of peripheral device, acquired by control section 1. In addition, coded-data converting section 7k performs the data-rearrangement processing while recognizing the block from header data, including numbers of pixels in both horizontal and vertical directions, arrangement of blocks, which are written in the file-header, and the length of the block at the tip portion of each code block.

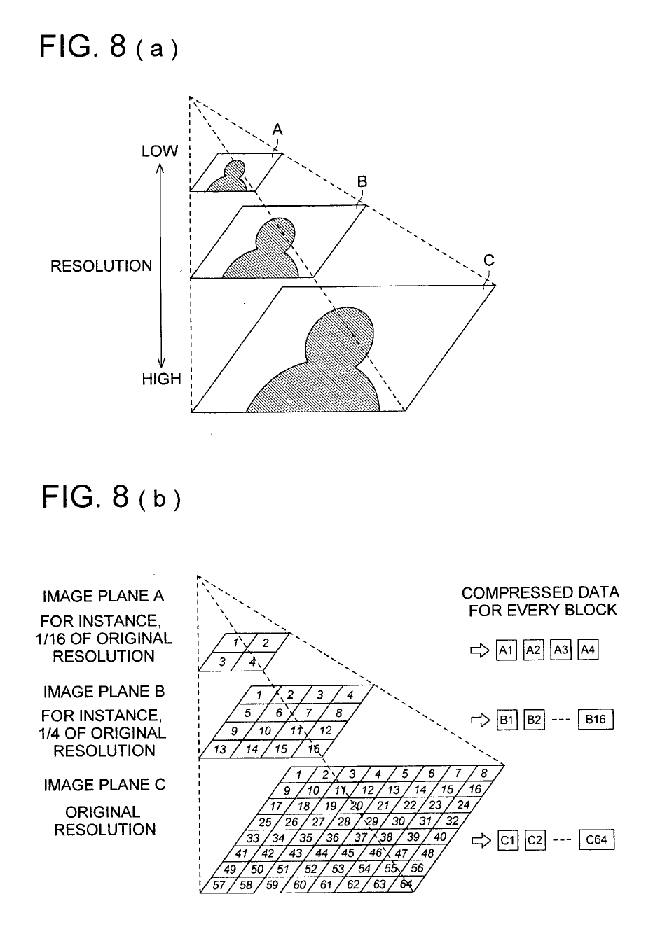

FIG. 8(a) and FIG. 8(b) show examples of a hierarchical expression of compressed image data, which are generated by applying arithmetic coding operation to each of the code blocks in the embodiment of the present invention, and are arranged from low to high resolutions. FIG. 8(a) shows an example, in which the resolution increases step by step from image A of low resolution to image B, and further, to image C. FIG. 8(b) shows each of compressed image data A1, A2, - - - , C69 for each block in images A, B, C. In the above drawings, although bit-planes for each of the resolutions are omitted in order to simplify the explanation, for instance, in compressed image data A1, there exist the coded data of the code block equivalent to its position for every bit-plane, which are handled and processed in the same manner as that for compressed image data A1.

In the embodiment of the present invention, when the peripheral device currently coupled to second interface 10 is, for instance, a portable remote terminal, coded-data converting section 7k rearranges data of the compressed image data file in such an order of A1, A2, A3, A4, B1, B2, B3, B4, B5, - - - , C63, C64, as shown in FIG. 7, on the basis of the acquired information pertaining to the kind of peripheral device, and the rearranged coded data are transmitted from coded-data outputting section 7f to the peripheral device currently coupled to second interface 10.

In the peripheral device (a portable remote terminal) to which the rearranged coded data are transmitted, a predetermined expansion processing is performed so as to reconstruct the image step by step from the low resolution image to the high resolution image, as shown in FIG. 8 (a). Thus, it becomes possible for the receiving side to recognize the contents of the image at the early stage of the transmitting operation.

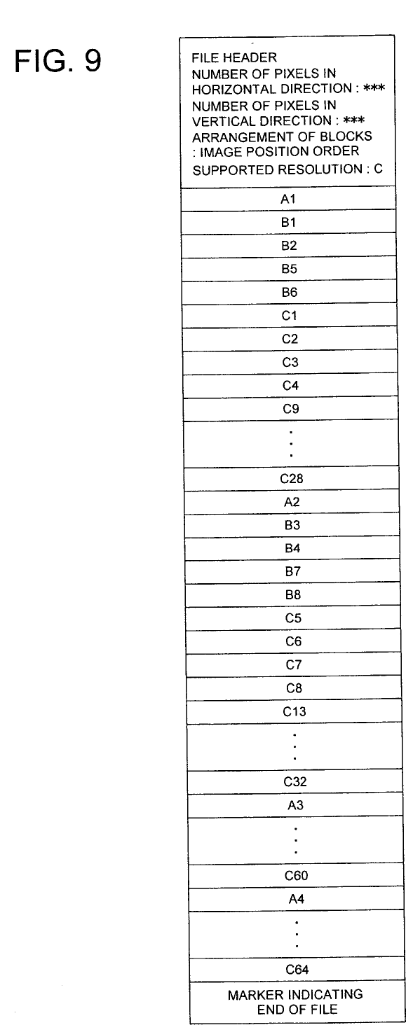

Further, when the peripheral device currently coupled to second interface 10 is a printer, coded-data converting section 7k rearranges data of the compressed image data file in such an order of A1, B1, B2, B5, B6, C1, C2, C3, C4, C9, C10, - - - as shown in FIG. 9, on the basis of the acquired information pertaining to the kind of peripheral device, and the rearranged coded data are transmitted from coded-data outputting section 7f to the peripheral device currently coupled to second interface 10.

Since the image is sequentially reconstructed by a predetermined expansion processing in the peripheral device (a printer), which receives the rearranged coded data, the printing operation can be immediately commenced from the upper end of the image, even in the mid-course of the data-communication.

Incidentally, as an embodiment of the present invention, when control section 1 already recognizes the image size being either displayable or printable for its peripheral device, from the information, pertaining to the kind of peripheral device, acquired by control section 1 through second interface 10, it is desirable that unnecessarily high-resolution image data are deleted from the hierarchical structured data before performing the data transmission.

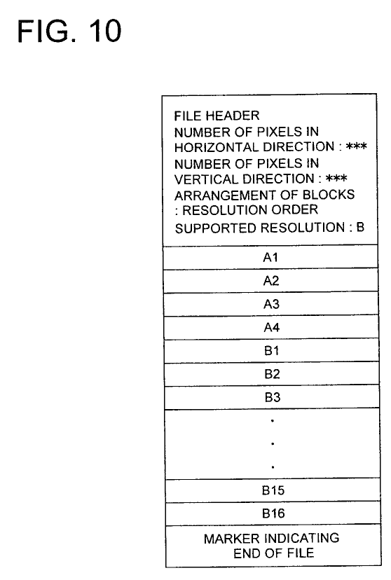

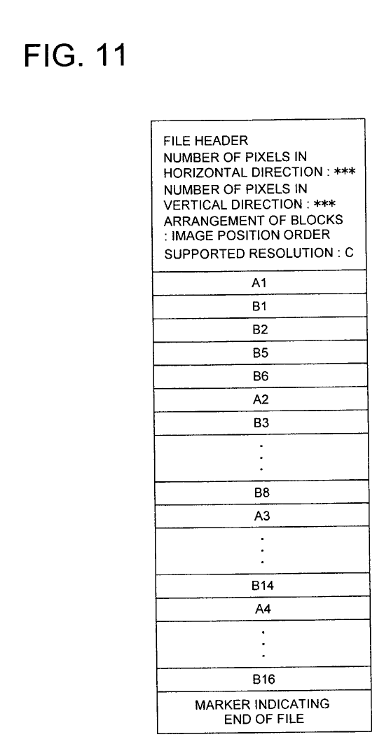

For instance, when the peripheral device at receiving side is a portable remote terminal, which cannot display such high-resolution image C as shown in FIG. 8(a), data of the compressed image data file are rearranged in such an order of A1, A2, A3, A4, B1, B2, - - - B15, B16 as shown in FIG. 10, to convert them to a new data format, in which high-resolution image data (namely, the image data of image plane C) are deleted, and the converted data are transmitted to the peripheral device (the portable remote terminal) through second interface 10.

Further, when the peripheral device at receiving side is a printer, which cannot print such high-resolution image C as shown in FIG. 8(a), data of the compressed image data file are rearranged in such an order of A1, B1, B2, B5, B6, A2, B3, - - - B15, B16 as shown in FIG. 10, to convert them to a new data format, in which high-resolution image data (namely, the image data of image plane C) are deleted, and the converted data are transmitted to the peripheral device (the portable remote terminal) through second interface 10.

Accordingly, since the image data are rearranged corresponding to the information pertaining to a kind of peripheral device and unnecessarily high-resolution image data are deleted from the image data before transmitting them to the peripheral devices, it becomes possible to transmit the image data more effectively than ever, resulting in a reduction of the time for data-transmission. In addition, since an amount of data to be transmitted can be corresponded to a memory capacity at the receiving side, it becomes possible to prevent such a trouble that the receiving side cannot receive the total amount of data sent by the sending side.

In case that the receiving side cannot receive the total amount of data, the sending side would intentionally delete a part of the image data to transmit the partially deleted image data to the peripheral device. Accordingly, it is preferable that a warning means, by which control section 1 displays a warning message on image displaying section 9 at the time of data-transmission, is equipped in the embodiment of the present invention, so that the user can confirm the present situation.

Further, it is also preferable that a selecting means, for selecting either a first mode in which partially deleted image data are transmitted to the peripheral device or a second mode in which image data are transmitted to the peripheral device as it is without partially deleting, is equipped in the embodiment of the present invention, so that the user can freely select either the first mode or the second mode. Alternatively, it is also possible to automatically select either the first mode or the second mode on the basis of the information sent from the peripheral device. Further, it is also applicable that the peripheral device sends a command signal for selecting either the first mode or the second mode to a digital still camera embodied in the present invention, and the digital still camera determines whether or not a part of the image data should be deleted before transmitting them to the peripheral device, based on the command signal sent from the peripheral device.

Incidentally, in the above embodiment, there has been described an example in which the transmitting order of the coded data is rearranged on the basis of the information pertaining to the peripheral devices, after generating the coded data in arithmetic processing section 7. Next, another embodiment, in which the coded-data generating method (the coding method) performed in arithmetic processing section 7 is determined on the basis of the information pertaining to the peripheral devices, will be detailed in the following.

Initially, bilateral data-communication with the external peripheral devices, such as a printer, a portable remote terminal, etc., are performed through second interface 10. In the embodiment of the present invention, control section 1 acquires the information pertaining to a kind of peripheral device, being either a printer or a portable remote terminal, etc., and the information pertaining to the outputting capacity of horizontal pixel number, vertical pixel number, etc., when commencing the bilateral data-communication with the external peripheral devices.

Next, control section 1 determines the data format, which is convenient for the peripheral device concerned, on the basis of the information pertaining to the kind of peripheral device, acquired through second interface 10.

Next, when a photographing operation is conducted by using the digital still camera, in the same manner as that of the aforementioned embodiment, signal processing section 6 converts chrominance components (R, G, B) of the digital image signals for every pixel to luminance color-difference signals, and sends them to arithmetic processing section 7, serving as an image processing means.

In arithmetic processing section 7, the image-compression processing, based on the coding method determined by control section 1, is applied to the luminance color-difference signals converted from the digital image signals.

Concretely speaking, when control section 1 determines that the peripheral device is a portable remote terminal, the hierarchical coding method is determined as a coding method to be employed. While, when control section 1 determines that the peripheral device is a printer, the sequential coding method is determined as a coding method to be employed.

With respect to the image data compressing method and the storing format for storing the compressed image data into the memory in the hierarchical coding method, the explanations for them are already described in the above and are omitted in the following. The image data compressing method and the storing format for storing the compressed image data into the memory in the sequential coding method will be detailed in the following.

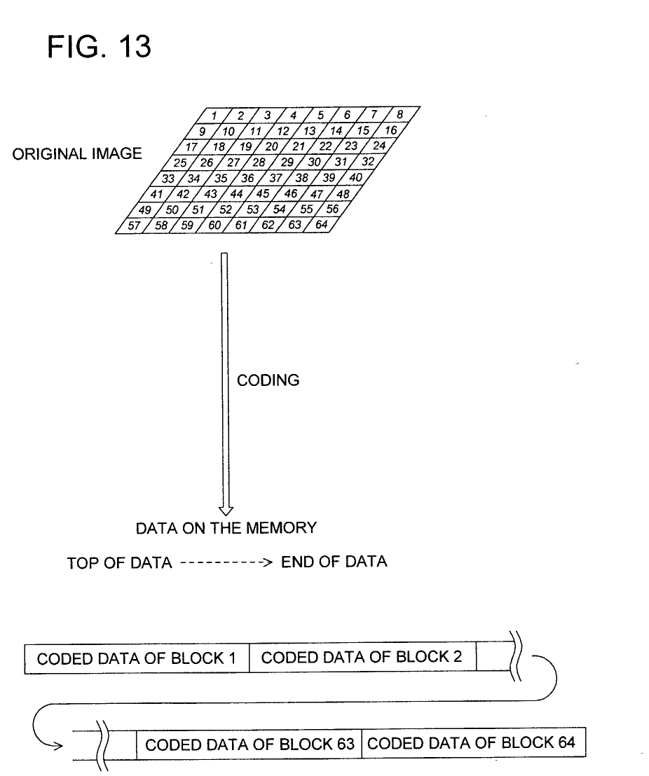

When the image data shown in FIG. 13 are compressed by employing the sequential coding method, the data-compression processing is applied to each of the data areas included in the image data of one image plane from the initial data area located at the top position of the image data (namely, area 1 at upper-left position in FIG. 13) to the final data area located at the end position of the image data (namely, area 64 at lower-right position in FIG. 13), and the compressed image data sets are stored in the memory in order of applying the data-compression processing.

Further, with respect to the image data to which the Wavelet transform is already applied, the image data sets, each of which corresponds to each of images A, B, C shown in FIG. 8(a), are successively generated in order of low-resolution image A, image B and high-resolution image C, and then, coding processing is applied to the blocks of each image plane from the upper-left block to the lower-right block in order of A1, B1, B2, B5, B6, C1, C2, C3, C4, C9, C10, C1, C12, - - - , C27, C28, A2, B3, B4, B7, B8, CS, C6, C63, C64, as shown in FIG. 8, to store the coded data in the memory in the same order as the above.

Accordingly, in case of reconstructing the image from the compressed image data stored in the memory after applying the data-compression processing to the image data in the sequential coding method, since the compressed image data are sequentially reconstructed into the image from the top of the whole memory area, in which the compressed image data to be reconstructed are stored, it becomes possible to start the reconstruction of the image having the final image quality from the upper-left pixels of the image and to complete the reconstruction of the image at the lower-right pixels. Therefore, it becomes possible to generate the image data being most suitable for the peripheral device, such as a printer, etc., which supports such the reconstructing method.

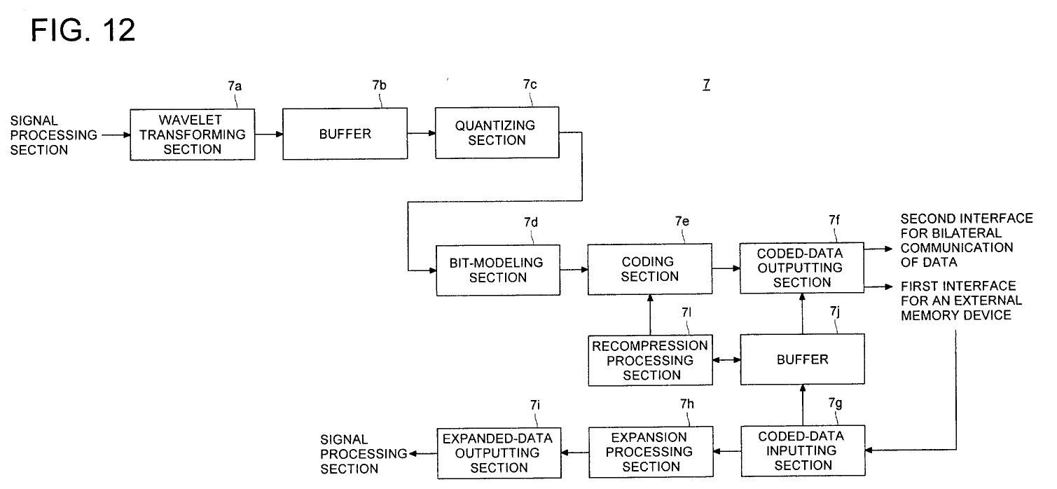

FIG. 12 shows a block diagram of a configuration of arithmetic processing section 7 of another digital still camera embodied in the present invention. The same blocks as those shown in FIG. 2 are indicated by the same reference numeral, and the detailed explanations for them are omitted in the following. In addition, since the whole configuration of the digital still camera is the same as that shown in FIG. 1, the detailed explanations for it are also omitted in the following.

The embodiment shown in FIG. 12 is characterized in that recompression processing section 71, serving as a recompressing means for recompressing the coded data once generated, is provided in arithmetic processing section 7.

In the same manner as that aforementioned, the image signals, inputted from signal processing section 6 into arithmetic processing section 7 (refer to FIG. 1), are processed in Wavelet transforming section 7a, quantizing section 7c, bit-modeling section 7d and coding section 7e, and then, the processed image data are outputted from coded-data outputting section 7f and stored in external memory device M through first interface 8.

Further, also in this embodiment, the bilateral data transmission with the external peripheral devices, such as a printer, a portable remote terminal, etc., is performed through second interface 10, serving as a data communication means. In this embodiment, when commencing the bilateral data transmission with the external peripheral devices, control section 1 acquires the information pertaining to a kind of peripheral device currently coupled to second interface 10, for instance, either a printer or a portable remote terminal.

Next, control section 1 reads the compressed image data file from external memory device M through first interface 8, and inputs them to coded-data inputting section 7g of arithmetic processing section 7.

The coded data, inputted to coded-data inputting section 7g, temporarily stored in buffer 7j, and then, in recompression processing section 71, the coded-data are recompressed on the basis of the information, pertaining to the kind of peripheral device, acquired by control section 1, so that the size of the coded-data coincides with the predetermined data-size corresponding to the peripheral device concerned.

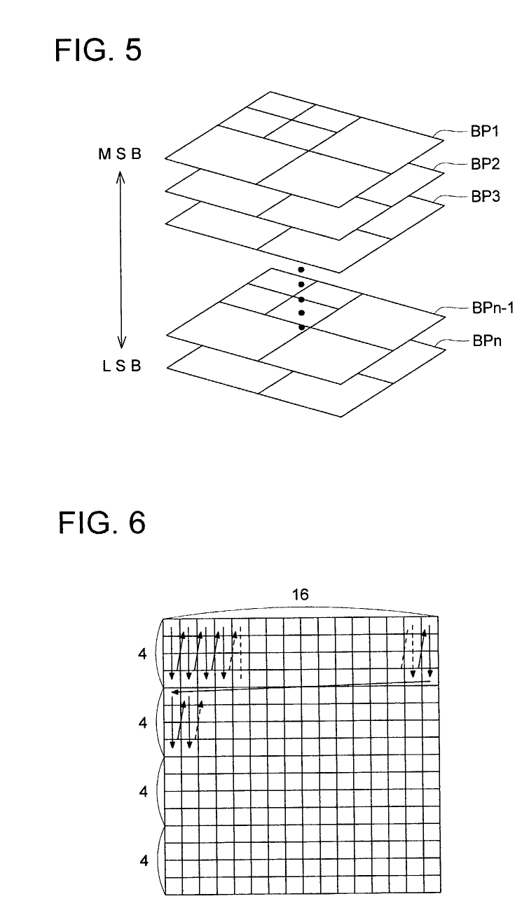

For instance, in recompression processing section 71, at fast, all of the coded blocks are decoded so as to reconstruct all of the bit-planes from MSB to LSB as shown in FIG. 5. Then, the LSB bit-plane is deleted to bit-shift the upper-level bit-plane. This processing is equivalent to the processing for applying the quantizing processing to Wavelet conversion coefficients.

In the same manner as aforementioned, the bit-planes, having revised data, are coded in coding section 7e, and then, the compressed image data file is outputted from coded-data outputting section 7f and stored in external memory device M through first interface 8. The generated file size can be adjusted by the bit-shift amount, and realized by repeating the bit-shift processing and the processing hereafter for getting to the desired data size.

According to the above embodiment, even when the size of the generated code data is too large for the peripheral device to which the code data are transmitted, it becomes possible to generate and transmit the code data, size of which is appropriate for the peripheral device, by performing the recompression processing, resulting in realization of the very good maneuverability.

Incidentally, although the abovementioned digital still camera is so constituted that the coded data generated in arithmetic processing section 7 are stored in detachable memory device M through first interface 8, it is also applicable that the coded data are stored in a memory device, such as a built-in memory, etc., incorporated in the digital still camera itself.

Further, provided that the data format and the data structure comply with the recognizable and reconstructable format in respect to each of the peripheral devices, any kinds of data format can be employed as the hierarchical structured data mentioned above. However, by employing the image data, which comply with the JPEG-2000 format internationally standardized at the end of 2000 year, the present invention can be embodied more easily.

According to the present invention, it becomes possible to provide an electronic device and a digital still camera having a good maneuverability, which make it possible to record or transmit the coded data in a format convenient to the peripheral device to which the coded data are transmitted.

Disclosed embodiment can be varied by a skilled person without departing from the spirit and scope of the invention.

What is claimed is:

1. An electronic device, comprising:
a processor to compress image data by coding said image data, so as to generate coded data;
a data communicating section to perform a bilateral data-communication with a peripheral device; and
a determining section to determine a coding method for coding said image data, based on information pertaining to said peripheral device, which are acquired by said data communicating section;
wherein said processor codes said image data on the basis of said coding method determined by said determining section to generate said coded data.

2. The electronic device of claim 1,
wherein said determining section determines an arrangement order of said coded data based on said information pertaining to said peripheral device, and said processor codes said image data based on said arrangement order of said coded data.

3. The electronic device of claim 2,
wherein said processor applies a Wavelet transform to said image data to generate hierarchical structured data for each of different frequency-bands, and divides said hierarchical structured data into a plurality of block areas, so that said image data are compressed by coding them in each of said plurality of block areas.

4. The electronic device of claim 2,
wherein said determining section determines either a hierarchical coding method or a sequential coding method as said coding method to be employed.

5. The electronic device of claim 4,
wherein, when said determining section determines said hierarchical coding method as said coding method to be employed, said processor generates said coded data based on said information pertaining to said peripheral device.

6. The electronic device of claim 1, further comprising:
a photographing optical system; and
an imager to opt-electronically convert an optical image, projected onto said imager by said photographing optical system, to said image data;
wherein said processor applies a Wavelet transform to said image data generated by said imager.

7. A digital still camera, comprising:
a photographing optical system;
an imager to opt-electronically convert an optical image, projected onto said imager by said photographing optical system, to image data;
a processor to compress said image data by coding said image data, so as to generate coded data;
a data communicating section to perform a bilateral data-communication with a peripheral device; and
a determining section to determine a coding method for coding said image data, based on information pertaining to said peripheral device, which are acquired by said data communicating section;
wherein said processor codes said image data on the basis of said coding method determined by said determining section to generate said coded data.

8. The digital still camera of claim 7,
wherein said determining section determines an arrangement order of said coded data based on said information pertaining to said peripheral device, and said processor codes said image data based on said arrangement order of said coded data.

9. The digital still camera of claim 8,
wherein said processor applies a Wavelet transform to said image data to generate hierarchical structured data for each of different frequency-bands, and divides said hierarchical structured data into a plurality of block areas, so that said image data are compressed by coding them in each of said plurality of block areas.

10. The digital still camera of claim 8,
wherein said determining section determines either a hierarchical coding method or a sequential coding method as said coding method to be employed.

11. The digital still camera of claim 10,
wherein, when said determining section determines said hierarchical coding method as said coding method to be employed, said processor generates said coded data based on said information pertaining to said peripheral device.

12. A digital still camera, comprising:
a photographing optical system;
an imager to opt-electronically convert an optical image, projected onto said imager by said photographing optical system, to image data;
an image-processing section to apply a Wavelet transform to said image data acquired by said imager to generate hierarchical structured data for each of different frequency-bands, and divides said hierarchical structured data into a plurality of block areas, so that said image data are compressed by coding them in each of said plurality of block areas;
a data communicating section to perform a bilateral data-communication with a peripheral device; and
a data conversing section to rearrange a transmitting order of coded data in each of said plurality of block areas in respect to said peripheral device, based on information pertaining to said peripheral device, which are acquired by said data communicating section.

13. The digital still camera of claim 12,
wherein said data conversing section rearranges said transmitting order of said coded data in either a first format in which said coded data are transmitted step by step from low-resolution to high-resolution, or a second format in which said coded data are sequentially transmitted.

14. The digital still camera of claim 13,
wherein, in case of employing said first format, said data conversing section deletes unnecessary high-resolution data from said coded data, based on said information pertaining to said peripheral device, which are acquired by said data communicating section.

15. The digital still camera of claim 14, further comprising:
a warning section to warn that a part of said coded data is deleted by said data conversing section.

16. An electronic device, comprising:
an image-processing section to apply a Wavelet transform to image data to generate hierarchical structured data for each of different-frequency-bands, and divides said hierarchical structured data into a plurality of block areas, so that said image data are compressed by coding them in each of said plurality of block areas;
a data communicating section to perform a bilateral data-communication with a peripheral device; and
a data conversing section to rearrange a transmitting order of coded data in each of said plurality of block areas in respect to said peripheral device, based on information pertaining to said peripheral device, which are acquired by said data communicating section.

17. A digital still camera, comprising:
a photographing optical system;
an imager to opt-electronically convert an optical image, projected onto said imager by said photographing optical system, to image data;
an image-processing section to apply a Wavelet transform to said image data acquired by said imager to generate hierarchical structured data for each of different frequency-bands, and divides said hierarchical structured data into a plurality of block areas, so that said image data are compressed by coding them in each of said plurality of block areas;
a data communicating section to perform a bilateral data-communication with a peripheral device; and
a recompressing section to recompress image data compressed by said image-processing section, based on information pertaining to said peripheral device, which are acquired by said data communicating section.

18. An electronic device, comprising:
an image-processing section to apply a Wavelet transform to image data to generate hierarchical structured data for each of different frequency-bands, and divides said hierarchical structured data into a plurality of block areas, so that said image data are compressed by coding them in each of said plurality of block areas;
a data communicating section to perform a bilateral data-communication with a peripheral device; and
a recompressing section to recompress image data compressed by said image-processing section, based on information pertaining to said peripheral device, which are acquired by said data communicating section.
